(19) United States
(12) Patent Application Publication
(10) Pub. No.: US 2003/0007010 A1
(43) Pub. Date: Jan. 9, 2003

(54) Providing alternate access for physically impaired users to items normally displayed in drop down menus on user-interactive display interfaces

(75) Inventors: Cristi Nesbitt Ullmann, Austin, TX (US); Lorin Evan Ullmann, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 09/845,463

(22) Filed: Apr. 30, 2001

(51) Int. Cl. G06F 3/14

(52) U.S. Cl. 345/810

(57) ABSTRACT

Alternate access for physically impaired users to items normally displayed in drop down menus is provided by furnishing to users conventional means for displaying a sequential set of drop down menus, each having a plurality of selectable items together with conventional selection means scrolled along each of said menus. However, if the user feels unable to use or frustrated in using such scrolling menu techniques, he has the option to choose to display, as an alternative to this set of sequential menus, a hierarchical arrangement of selectable items corresponding to items in said set of menus. In the case where the menus in the sequential set of drop down menus sequentially vary from each other in scope, then the alternative hierarchical arrangement of selectable items may be a tree of items with sequential levels of varying scope respectively corresponding to the varying scope of said set of menus. The selectable items in the tree may be icons and particularly icons varied in size so as to be optimized to diminish the effects of the individual user's impairment. For the same effect, the icons in the tree may also be varied in distance from each other so as to be optimized to diminish the effects of the individual user's impairment.

### CROSS REFERENCE

U.S. patent application entitled PROVIDING A USER INTERACTIVE INTERFACE FOR PHYSICALLY IMPAIRED USERS DYNAMICALLY MODIFIABLE RESPONSIVE TO PRELIMINARY USER CAPABILITY TESTING (Attorney Docket No. AUS9-2001-0432-US1) having the same inventors and assignee of the present application, and filed concurrently herewith.

### TECHNICAL FIELD

The present invention relates to user-interactive computer supported display technology and particularly to such user-interactive systems and methods which are user friendly and provide physically and visually impaired computer users with an interface environment which is easy to use, particularly with respect to screen cursor movements.

### BACKGROUND OF RELATED ART

The past decade has been marked by a technological revolution driven by the convergence of the data processing industry with the consumer electronics industry. This advance has been even further accelerated by the extensive consumer and business involvement in the Internet over the past several years. As a result of these changes, it seems as if virtually all aspects of human endeavor in the industrialized world require human-computer interfaces. These changes have made computer directed activities accessible to a substantial portion of the industrial world's population, which, up to a few years ago, was computer-illiterate, or, at best, computer indifferent.

However, even more significant than these advances in opening new horizons to the general population has been the ability of the computer and the Internet to rescue people with even very severe physical impairments from lives of limited menial or no productivity. With the computer any impaired person with even slight dexterity or vision may, with sufficient effort, be capable of becoming as fully productive from his desktop as a person with full dexterity or vision.

This is possible because, unlike the workplaces of the past which presented global or universal working conditions where each worker had to adjust to thereby eliminate most physically or visually impaired people, the computer may be tailored to the unique abilities of each physically impaired individual. To this end, the computer industry is continuously seeking new implementations to bring more and more physically impaired individuals into full productivity in the workforce.

One source of frustration to physically and visually impaired computer users has been movement of the screen cursor and like movable screen indicia to make the required user-interactive selections. Despite all of the great changes that have been made in the computer industry, the screen cursor controlled manually by the user still remains the primary human-computer interface. The user still commands the computer primarily through manual pointing devices such as mice, joy sticks and trackballs that control the on-screen cursor movements. It must be noted that the principles involved in such pointing devices were developed over a generation ago when most of the people involved in interfaces to computers were computer professionals who were willing to invest great amounts of time in developing computer skills. It is very possible that had computers originally been the mass consumer, business and industry implements which they are today, user interfaces which were much easier and required less skill to use would have been originally sought and developed. Nonetheless, the manually controlled cursor movement devices remain our primary implement for cursor control. The present invention is directed to making mouse, trackball and the like cursor control devices more user friendly and effective for the physically and visually impaired.

Cursor control devices, such as the mouse, translate relatively precise orthogonal manual movements into precise cursor movements on the display screen. Users with poor hand-eye coordination due to poor eyesight, physical impairment, feebleness or other dexterity problems find the computer mouse to be quite stressful and frustrating.

### SUMMARY OF THE PRESENT INVENTION

The present invention is directed to interactive computer controlled display systems and particularly to methods in such systems for making the cursor easier to use and control in making on-screen movements and selections of displayed objects such as icons. The drop down menu has become a primary means of interactive user selection of items or objects in interactive displays. These menus also referred to as pull down menus or cascading menus are arranged in menu sets with each menu representing a category of items at one level in a descending sequence of scope levels. Each user item selection at a given level permits to user to scroll through the menu of next lower scope level items in a cascading sequence. These drop down menus became particularly popularized through their widespread use in the Microsoft's Windows operating systems.

While cursoring through drop down menus and making selections therefrom can eventually be mastered by persons without physical or visual impairments, the drop down and like menus, such as pop-up menus, are very frustrating and frequently impossible to use by the physically or visually impaired. Controlling a cursor to scroll up or down a list of items running vertically in narrow item bands is extremely difficult for the impaired. Similarly, moving the cursor to a small scroll button at a menu and then holding the button down in a steady position while the menu scrolls itself down may be equally frustrating for physically impaired users.

The present invention offers a solution to these problems with scrolled menus by providing alternate access for physically impaired users to items normally displayed in drop down menus which involves furnishing to users conventional means for displaying a sequential set of drop down menus, each having a plurality of selectable items together with conventional selection means scrolled along each of said menus. However, if the user feels unable to use or frustrated in using such scrolling menu techniques, he has the option to choose to display as an alternative to this set of sequential menus a hierarchical tree arrangement of selectable items corresponding to items in said set of menus. In the case where the menus in the sequential set of drop down menus sequentially vary from each other in scope, then the alternative hierarchical arrangement of selectable items may be a tree of items with sequential levels of varying scope respectively corresponding to the varying scope of the set of menus.

In accordance with a preferred aspect of the invention, the selectable items in the tree are icons, and particularly icons varied in size so as to be optimized to diminish the effects of the individual user's impairment. For the same effect, the icons in the tree may also be varied in distance from each other so as to be optimized to diminish the effects of the individual user's impairment.

The invention further provides for an implementation which includes means for tracking use characteristics of an individual user; and means responsive to this tracking for dynamically varying said sizes of said icons. Among pertinent user characteristics that may thus be tracked, is the extent to which particular icons are used. An implementation is provided including means for counting the number of times that each of a plurality of icons are selected; and means responsive to said counting means for varying the sizes of said icons relative to the selection counts of said icons. This implementation may also be set up to temporarily dynamically eliminate from the tree, icons that are never or rarely used.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit which provides the computer controlled interactive display system which may be used in practicing the present invention;

FIG. 2 is a diagrammatic view of a display screen illustrating three levels of cascaded drop down menus in which cursor pointed selections have been made to drop down the third level shown;

FIG. 3 is the diagrammatic display view of FIG. 2 after the user has selected to work with the alternative hierarchical tree of icons corresponding to the set of menus of FIG. 2;

FIG. 4 is an illustration of a display screen with simplified user-interactive dialog that may be used to determine the ability of a user to select icons of varying size to determine optimum icon or object sizes; and

FIG. 5 is a flowchart of the steps involved in applying the system of the present invention to provide impaired users with alternative hierarchical tree access to items normally displayed in drop down menus.

### DETAILED DESCRIPTION OF THE PREFERRED EMBODIMENT

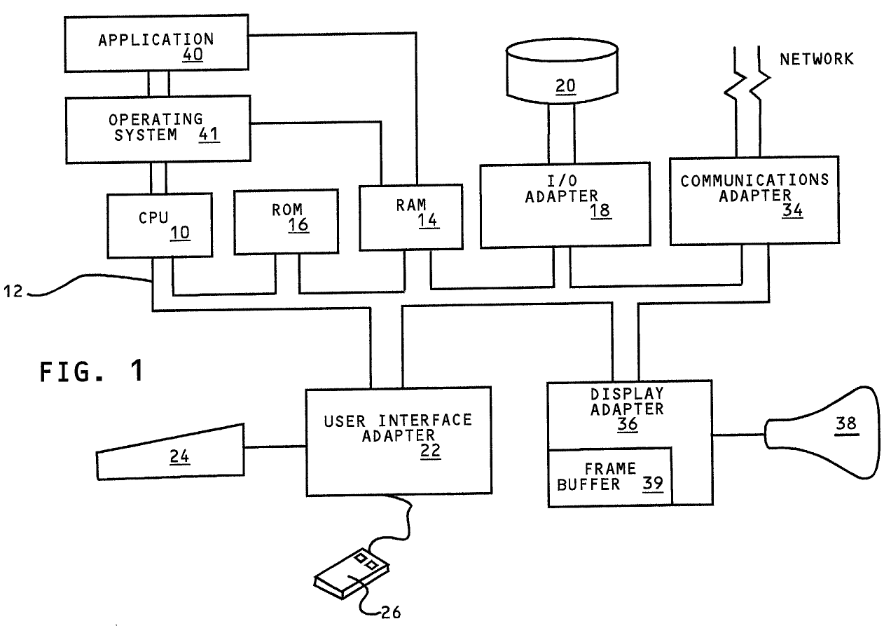

Referring to FIG. 1, a typical data processing system is shown which may function as the computer controlled display terminal used in implementing the system of the present invention for providing impaired users with alternative hierarchical tree access to items normally displayed in drop down menus. A central processing unit (CPU) 10, such as any PC microprocessor in a PC available from IBM or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's Windows98™ or WindowsNT™, as well as the UNIX or AIX operating systems. An application program, that will be subsequently described in detail, runs in conjunction with operating system 41 and provides output calls to the operating system 41, which in turn implements the various functions to be performed by the application programs 40 that include the program of the present invention providing impaired users with alternative hierarchical tree access to items normally displayed in drop down menus to be hereinafter described in greater detail.

A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20, i.e. a hard drive. Communications adapter 34 interconnects bus 12 with an outside network enabling the data processing system to communicate with other such systems over a Local Area Network (LAN) or Wide Area Network (WAN), including the Internet. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned mouse or related devices, a user is capable of inputting information to the system through the keyboard 24 or mouse 26 and receiving output information from the system via display 38.

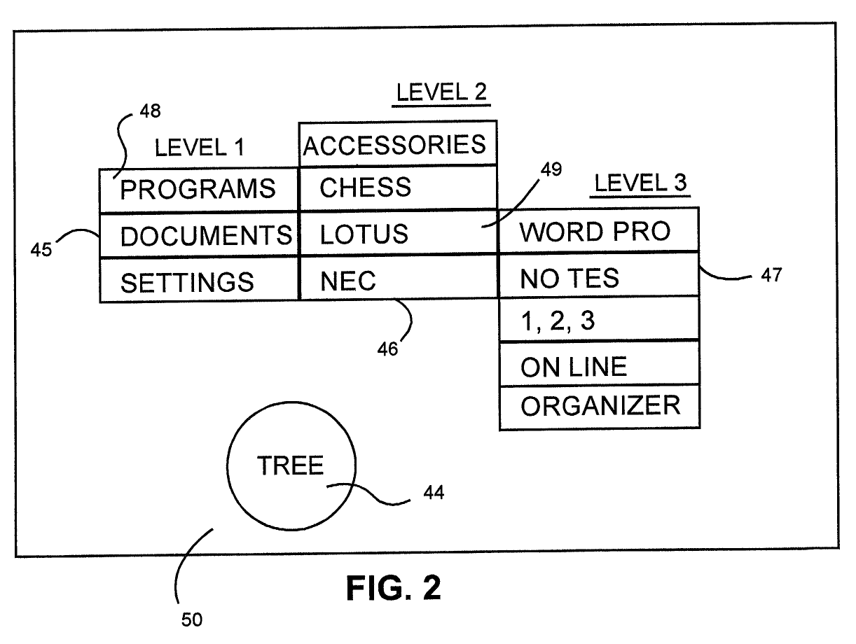

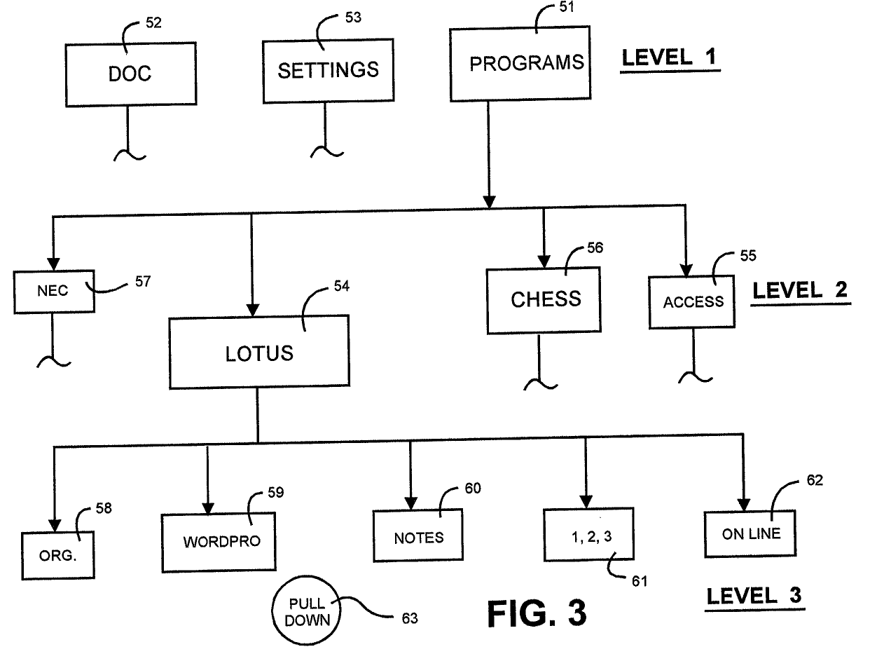

In the diagrammatic illustration of FIG. 2, a display screen 50 is shown with a sequence of three cascading drop down menus: menu 45 (Level 1); menu 46 (Level 2); and menu 47 (Level 3). The sequence presents choices in menus of items representing categories of decreasing scope. In the sequence shown, the user has selected “PROGRAMS” from menu 45 which resulted in drop down menu 46 and “LOTUS” from menu 46 which resulted in drop down menu 47. At any point in this process, the user could cursor to and select the “TREE” button 44 and thereby shift to the alternative hierarchical tree layout of tailored icons to be subsequently described with respect to FIG. 3. It is to be noted that the user may click on the TREE button at any point. He may do so initially even before he gets the first drop down menu 45. In such a case, he would get the whole tree displayed in FIG. 3 with all of its branches, i.e. at Level 1, all of the branches respectively from each of Doc icon 52 and Settings icon 53 right down to the third level, as well as at Level 2, all of the branches from each of NEC icon 57, Lotus icon 54, Chess icon 56 and Access icon 55 also down to Level 3. For convenience in illustration, Doc icon 52, Settings icon 53, NEC icon 57, Lotus icon 54, Chess icon 56 and Access icon 55 are shown with their downward branches cut off.

Even if the user has commenced using the drop down menu sequence display of FIG. 2, should he find that he is having difficulty in scrolling and selecting through the drop down menus, he may then click on the TREE button 44 to thereby cause the display hierarchical tree of FIG. 3. Dependent on the needs and wishes of the user, the tree of FIG. 3 may be set up to show the complete tree, i.e. all of the icons branching from all of the icons at each of the levels right down to the bottom or third level in the illustration. On the other hand, if the user has already made choices from the drop down menus at one or two of the levels prior to selecting the TREE button 44, then the displayed tree may be set up to display only the icons already selected at levels corresponding to menus where selections have been made together with all of the icons at unselected levels.

At any point in the operation described with respect to FIG. 3, the user may return to the drop down or pull down menus of FIG. 2 by pressing the “Pull Down” button 63. This will conveniently return the user to the drop down menus at a menu item corresponding to the last icon selected in the tree of FIG. 3.

It may turn out that the initial or basic tree shown in FIG. 3 may be too large or extensive for the display screen. In the present day workplace, the user may be operating from several different computer controlled displays, e.g. laptop or palm device, in addition to his basic desktop computer. These displays are of different sizes. Thus, the user may be given the option of selecting hierarchical trees of different sizes to be displayed. In addition to Pull Down button 63 in FIG. 3, the user may be offered a set of Tree buttons, e.g. Tree1, Tree2, . . . TreeN, which will respectively change the display to trees of different sizes and extensiveness so that the user may optimize the size of the hierarchical tree to the size of the display screen. The user may also be permitted to predetermine the optimum tree size for each particular display screen so that the system program will select the tree size as set forth in the following object oriented pseudocode example:

MenuObject oldMenuItems;
oldMenuItems = getOriginalMenuItems();
int largerDisplay = 1048;
DisplayStorage display = getDisplayType();
int r = display.Resolution = getresolution();
if (r>largeDisplay)

useEntireTree=true

else

useEntireTree=false;

If (useEntireTree) {

//render the new hierarchical tree
RenderTheEntireHierarchicalTree (oldMenuItems);

} else {

//check other types of hierarchical trees
if (doesAnotherTypeofTreeExistsThatCanBeDisplayed)
{

Hashtable h = getPossibleTreeTypes();
for AllHashElements loop

int TreeType=getElement();
if (TreeType=star)

//Render the entire tree if possible
renderAsStarHierarchicalTree()
exit();
. . .

}
displayForwardandBackButtons()
displayFirstPartofTree();
loop forever

if (displayNextPartofTreeButtonIsPushed)
{

getNextPartofTree();
renderTheHierarchicalTreePart();

} else {

continue;

}

}

The icons 51 through 62 at Levels 1, 2 and 3 of the tree in FIG. 3 respectively correspond to the menu items at Levels 1, 2 and 3 in the cascading drop down menus in FIG. 2. However, the icons are varied substantially in size and spacing between icons to make such icons easier to perceive and to cursor to by any physically or visually impaired user. The sizes and spacing are tailored to the user's impediments relative to the user's needs in performing his work. The sizing and/or spacing of the icons in the tree of FIG. 3 may be set up or modified by anyone who sets up the computer interface for the specific user using standard icon moving and graphic techniques available in operating systems, such as the Windows series for expanding or contracting dimensions. Also, sizing and spacing of icons in the tree of FIG. 3 may be done dynamically by routines which monitor user behavior patterns and adjust sizing and/or spacing accordingly. For example, the tree of FIG. 3 may be set up in an initial or default pattern. Then, the user activity with respect to the specific icons may be monitored, e.g. the number of times that a user selects each icon my be counted, and the size of the icons dynamically modified based upon such counts. In this respect, if it is found that a particular icon is rarely or never selected, it may be eliminated from the tree in order to provide for better spacing.

In addition to resizing, the tree elements or icons may be reordered in position from the original ordering that was based upon the order of items in the drop down menus. Accordingly, more frequently used icons may be moved to the top or center of the display screen so they are more accessible to the impaired user. For example, a set up may be provided wherein each icon has a listener for its number of hits (uses). The numbers of uses may be mapped back to the re-rendering of the icons' positions. An example of this type of process is set forth in the following object oriented pseudocode: An object class named HierarchicalTree keeps track of the current position of each icon based upon the usage of that icon. If adaptive usage is true, then the order of each element is determined each time the original menu is used.

class HierarchicalUsageTree {

//Render information
Rectangle size;
Vector HierarchicalTreeElements;
Vector originalOrderAllElement =

getOriginalOrder(oldMenuItems);

//Usage Methods
adaptiveUsage = getUserPreferences;
boolean isAdaptive () {

if ( adaptiveUsage )

return true;

else

return false;

}
static public reorderHierarchicalTree () {

forAllHierarchicalElements loop

getUsageHits
if(UsageHits of this element >

UsageHits of last element)
//switch positions in

newOrderAllElements vector

}

}
class HierarchicalTreeElement {

boolean orderChangeFromOriginal;
int NumberOfUsageHits;
int () {

originalOrder = getOriginalOrder(oldMenuItems);
NumberOfUsageHits = 0;

}
usageHitOccurred () {

NumberOfUsageHits + 1;
HierarchicalUsageTree.reorderHierarchicalTree

();

}

}

As set forth above, the user may predetermine the number of hits required to re-render a portion of a tree. The following pseudocode gives an example of this:

class UsageReRender {

int NumberOfHitsNeededToRerender;
boolean reRenderNeeded ( HierarchicalUsageTree ) {

//accumulate a count of all usage hits
int totalHits
for all elements loop

calculate totalHits

if (totalHits > NumberOfHitsNeededToRerender)

return true;

else

return false;

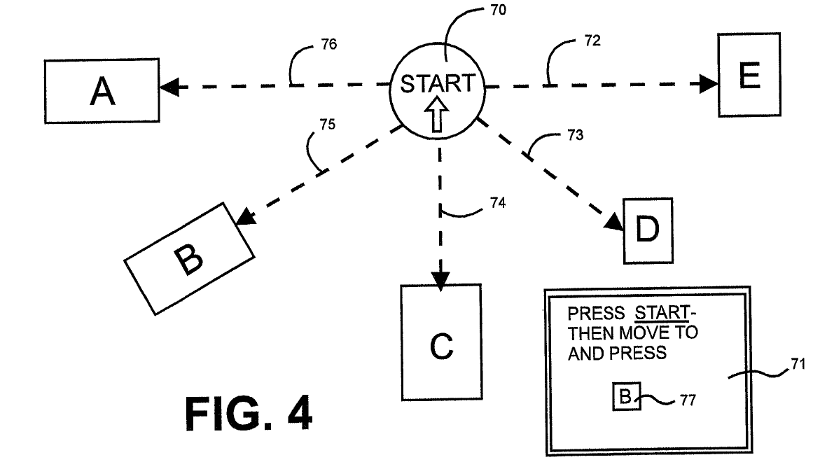

The above-described copending application (Attorney Docket No. AUS9-2001-0432-US1) covers a user function testing embodiment, wherein the user may be given preliminary tests by the computer to determine his eye-hand coordination and the icons sized and spaced accordingly. FIG. 4 is a simplified illustration of such a test. In a preliminary display, there is a starting circle or point 70 into which the user initially moves the cursor. Five icons A, B, C, D and E of varying sizes but having respective paths, 72, 73, 74, 75 and 76 of equal distance from starting circle 70 are displayed. The user is then prompted through dialog panel 71 to move from the circle 70 to the specified icon as listed in box 77 and to press the icon. The amount of time taken is recorded. The user is then prompted to return the cursor to Start 70, after which the user is prompted to move to another icon and the time is recorded. This procedure is repeated until a reasonable sampling is obtained. Since the distances of paths 72 through 76 traversed by the cursor are the same, the differences in average time have to be dependent upon the variation in the sizes of icons A through E. The system has predetermined what a reasonable time is and, thus, selects the icon size that results in a time closest to such a predetermined time. This is only intended to be a simplified illustration of determining user capability and it is understood that commercial embodiments may be more complex.

Another advantage of the alternative hierarchical tree of this invention is that it permits the impaired user to access the item through its icon in order to get help or a better definition of an icon image through a flyover (i.e. a box or a balloon giving more information) a better definition or help to a user holding or hovering a cursor above an item or icon. A physically impaired user may experience great difficulty in hovering or holding his cursor over a small item in a drop down menu for the amount of time that it takes to get a complete flyover. However, the relatively large icons in the alternative tree of the present invention make such hovering or holding by an impaired user much easier.

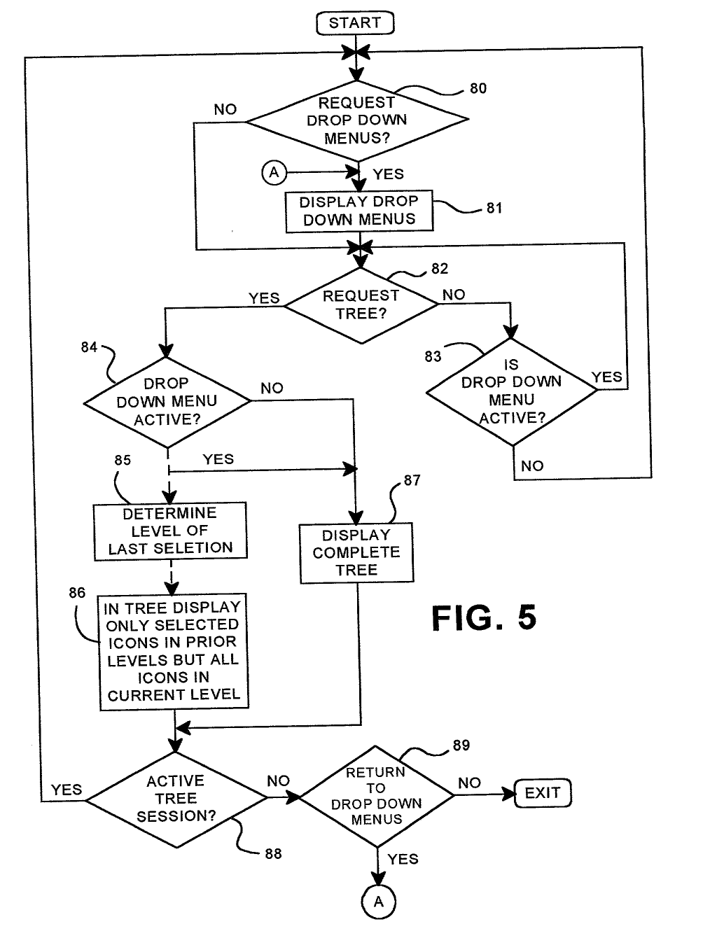

Now with reference to FIG. 5, we will describe a process implemented by the present invention in conjunction with the flowchart of this figure. An initial determination is made as to whether there has been a request for a drop down menu, step 80. If Yes, then the drop down menu sequence is displayed and manipulated by the user, step 81. At this point, or if the determination from step 80 had been No, a determination is made, step 82, as to whether the user has requested the alternative hierarchical tree display. If No, then a determination is made as to whether the drop down menus are still active, step 83. If Yes, then the process is returned to step 82 where the drop down menus continue to be displayed until a tree is requested. If the decision from step 83 is No, then the process is returned to initial step 80 where the next request is awaited.

Returning now to step 82, if Yes, then a further determination is made as to whether the drop down menu sequence is still active, step 84. If Yes, then two options are available: a) the complete hierarchical tree may be displayed, step 87, as described above with respect to FIG. 3; or b) as shown in the dotted line flow path, the menu level of the last menu selection may be determined and then only the icons corresponding to the menu selected items in prior levels are shown in the tree together with all of the icons in the current level, step 86. Also, if it is determined that there is No active drop down menu, step 84, then the complete tree is displayed, step 87. Thus, there is a continuing determination made, step 88, that the tree session remains active. If Yes, then it continues until either interrupted by a request for a drop down menu, step 80, or, if No, then the session is at an end. At such a point, a determination is made as to whether there has been a new request for drop down menus, step 89. If Yes, the session is returned to step 81 via flow branch “A” where the drop down menus are displayed. If No, the session is exited.

One of the preferred implementations of the present invention is as an application program made up of programming steps or instructions resident in RAM 14, FIG. 1, during computer operations. Until required by the computer system, the program instructions may be stored in another readable medium, e.g. in disk drive 20, or in a removable memory such as an optical disk for use in a CD-ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled user-interactive display system, a display interface implementation for providing alternate access for physically impaired users to items normally displayed in drop down menus comprising:
means for displaying a sequential set of drop down menus, each having a plurality of selectable items;
selection means scrolled along each of said menus; and
means enabling a user to selectively display as an alternative to said set of menus, a hierarchical arrangement of selectable items corresponding to items in said set of menus.

2. The display interface implementation of claim 1 wherein:
the menus in said sequential set of drop down menus sequentially vary from each other in scope; and
said alternative hierarchical arrangement of selectable items is a tree of said items with sequential levels of varying scope respectively corresponding to the varying scope of said set of menus.

3. The display interface implementation of claim 2 wherein said selectable items in said tree are icons.

4. The display interface implementation of claim 3 wherein said icons are varied in size so as to be optimized to diminish the effects of the individual user's impairment.

5. The display interface implementation of claim 4 wherein said icons in said tree are varied in distance from each other so as to be optimized to diminish the effects of the individual user's impairment.

6. The display interface implementation of claim 4 further including:
means for tracking use characteristics of an individual user; and
means responsive to said tracking means for dynamically varying said sizes of said icons.

7. The display interface implementation of claim 4 further including:
means for tracking use characteristics of an individual user; and
means responsive to said tracking means for eliminating rarely used icons from said tree.

8. The display interface implementation of claim 6 wherein said means for tracking use characteristics of an individual user includes:
means for counting the number of times that a plurality of icons are selected; and
means responsive to said counting means for varying the sizes of said icons relative to the selection counts of said icons.

9. A method for providing alternate access for physically impaired users to items normally displayed in drop down menus in computer controlled user-interactive display systems comprising:
displaying a sequential set of drop down menus, each having a plurality of selectable items;
enabling a user to select items from each of said menus by scrolling along each of said menus; and
enabling a user to selectively display as an alternative to said set of menus, a hierarchical arrangement of selectable items corresponding to items in said set of menus.

10. The method for providing alternate access for physically impaired users of claim 9 wherein:
the menus in said sequential set of drop down menus sequentially are varied from each other in scope; and
said alternative hierarchical arrangement of selectable items is arranged in a tree of said items with sequential levels of varying scope respectively corresponding to the varying scope of said set of menus.

11. The method for providing alternate access for physically impaired users of claim 10 wherein said selectable items in said tree are icons.

12. The method for providing alternate access for physically impaired users of claim 11 including the further step of varying said icons in size to optimize said tree to diminish the effects of the individual user's impairment.

13. The method for providing alternate access for physically impaired users of claim 12 including the further step of varying said icons in said tree in distance from each other to optimize said tree to diminish the effects of the individual user's impairment.

14. The method for providing alternate access for physically impaired users of claim 12 further including the steps of:
tracking use characteristics of an individual user; and
dynamically varying said sizes of said icons responsive to said tracking.

15. The method for providing alternate access for physically impaired users of claim 12 further including the steps of:
tracking use characteristics of an individual user; and
dynamically eliminating rarely used icons from said tree responsive to said tracking.

16. The method for providing alternate access for physically impaired users of claim 14 wherein said tracking use characteristics of an individual user includes the steps of:
counting the number of times that a plurality of icons are selected; and
varying the sizes of said icons relative to the selection counts of said icons.

17. A computer program having program code included on a computer readable medium for providing alternate access for physically impaired users to items normally displayed in drop down menus in computer controlled user-interactive display systems comprising:
means for displaying a sequential set of drop down menus, each having a plurality of selectable items;
selection means scrolled along each of said menus; and
means enabling a user to selectively display as an alternative to said set of menus, a hierarchical arrangement of selectable items corresponding to items in said set of menus.

18. The computer program of claim 17 wherein:
the menus in said sequential set of drop down menus sequentially vary from each other in scope; and
said alternative hierarchical arrangement of selectable items is a tree of said items with sequential levels of varying scope respectively corresponding to the varying scope of said set of menus.

19. The computer program of claim 18 wherein said selectable items in said tree are icons.

20. The computer program of claim 19 wherein said icons are varied in size so as to be optimized to diminish the effects of the individual user's impairment.

21. The computer program of claim 20 wherein said icons in said tree are varied in distance from each other so as to be optimized to diminish the effects of the individual user's impairment.

22. The computer program of claim 20 further including:
means for tracking use characteristics of an individual user; and
means responsive to said tracking means for dynamically varying said sizes of said icons.

23. The computer program of claim 20 further including:
means for tracking use characteristics of an individual user; and
means responsive to said tracking means for eliminating rarely used icons from said tree.

24. The computer program of claim 22 wherein said means for tracking use characteristics of an individual user includes:
means for counting the number of times that a plurality of icons are selected; and
means responsive to said counting means for varying the sizes of said icons relative to the selection counts of said icons.

25. The display interface implementation of claim 6 wherein said means for tracking use characteristics of an individual user includes:
means for counting the number of times that a plurality of icons are selected; and
means responsive to said counting means for varying the locations of said icons in said hierarchical tree relative to the selection counts of said icons.

26. The method for providing alternate access for physically impaired users of claim 14 wherein said tracking use characteristics of an individual user includes the steps of:
counting the number of times that a plurality of icons are selected; and
varying the locations of said icons in said hierarchical tree relative to the selection counts of said icons.

27. The computer program of claim 22 wherein said means for tracking use characteristics of an individual user includes:
means for counting the number of times that a plurality of icons are selected; and
means responsive to said counting means for varying the locations of said icons in said hierarchical tree relative to the selection counts of said icons.
